(19) United States
(12) Patent Application Publication
(10) Pub. No.: US 2016/0224379 A1
(43) Pub. Date: Aug. 4, 2016

(54) Mapping Processes to Processors in a Network on a Chip Computing System

(71) Applicant: The Intellisis Corporation, San Diego, CA (US)

(72) Inventor: Douglas A. PALMER, San Diego, CA (US)

(73) Assignee: The Intellisis Corporation, San Diego, CA (US)

(21) Appl. No.: 14/608,505

(22) Filed: Jan. 29, 2015

(51) Int. Cl. G06F 9/50; G06F 11/30; G06F 11/34

(52) U.S. Cl. CPC G06F 9/5011; G06F 11/3409; G06F 11/3024

(57) ABSTRACT

Systems and methods may be provided to execute a plurality of computation tasks across a plurality of computing resources of a computing system. In one aspect, a computer-implemented method may execute a software application comprising a plurality of tasks on a computing system. The method may comprise loading the software application into the computing system, assigning the plurality of tasks to a plurality of computing resources of the computing system according to a first assignment, executing the plurality of tasks on the plurality of computing resources according to the first assignment. Each processing resource may be configured to generate and collect system activity monitoring (SAM) data. The method may further comprise collecting the SAM data from the plurality of processing resources, performing an analysis of the first assignment based on the collected SAM data and determining an adjustment to the first assignment based on the analysis.

### FIELD OF THE DISCLOSURE

The systems, methods and apparatuses described herein relate to a computing system having a plurality of multi-core processors and distributing multiple tasks of a computer application to the plurality of multi-core processors.

### BACKGROUND

Parallel processing has been implemented in computer systems for a long time. For example, from the early day mainframe computers to modern day personal computers, laptops, tablets or smartphones, parallel processing has been implemented using a combination of hardware and software capable of taking advantage of the hardware. Hardware support normally includes multiple processors and a shared memory between the processors (such as a Symmetric Multiprocessing (SMP) system), or using a co-processor (such as a graphical processor unit (GPU)) to handle certain computation intensive tasks. Software taking advantage of the hardware support may include program code having annotations, such as Open Multi-Processing (OpenMP), or program code implementing Portable Operating System Interface (POSIX) threads.

Existing parallel processing techniques, however, put substantial burden on programmers to manage and control the parallel processing. For example, the programmers have to create “threads” to execute tasks in parallel and make sure the “threads” synchronize at certain points. Also, the programmers have to determine how to allocate tasks to the “threads,” to different processors, and/or to co-processors. Therefore, developing parallel software with the existing systems often increases costs, increases the number of software bugs, and is quite limited with respect to the degree of parallelism that can be achieved. Accordingly, there is a need in the art for a computing system that may determine the mapping of tasks to processors dynamically and adaptively.

### SUMMARY

The present disclosure provides systems, methods and apparatuses for executing a computer application in a computing system. The computing system may comprise a plurality of processing engines and each processing engine may generate and store performance data in a non-transitory storage to support monitoring and debugging of system performance. The computing system may collect the performance data from the plurality of processing engines. Tasks and processes can be balanced and/or assigned within the computing system based on the performance data gathered during monitoring.

In one aspect of the disclosure, a computer-implemented method may execute a software application comprising a plurality of tasks on a computing system. The method may comprise loading the software application into the computing system, assigning the plurality of tasks to a plurality of computing resources of the computing system according to a first assignment, executing the plurality of tasks on the plurality of computing resources according to the first assignment. Each processing resource may be configured to generate and collect system activity monitoring (SAM) data. The method may further comprise collecting the SAM data from the plurality of processing resources, performing an analysis of the first assignment based on the collected SAM data and determining an adjustment to the first assignment based on the analysis.

In another aspect of the disclosure, a computing system may be configured to execute a plurality of tasks of a software application in parallel. The computing system may comprise a host and a plurality of computing resources configured to execute program code. Each computing resource may comprise a system activity monitoring (SAM) instrument configured to generate and collect SAM data. The host may be configured to load the software application into the computing system, assign the plurality of tasks to the plurality of computing resources according to a first assignment, execute the plurality of tasks on the plurality of computing resources according to the first assignment, collect the SAM data from the plurality of processing resources, perform an analysis of the first assignment based on the collected SAM data; and determine an adjustment to the first assignment based on the analysis.

In a further aspect of the disclosure, the computing system may comprise a plurality of processing devices, each processing device may comprise a plurality of processing engines grouped into one or more clusters, and a plurality of clusters may optionally be grouped into a super cluster, and each processing resource may be one of a processing device, a cluster, an optional super cluster, or a processing engine. Each processing resource may implements a SAM instrument to generate and collect SAM data.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1A is a block diagram of an exemplary computing system according to the present disclosure.

FIG. 1B is a block diagram of an exemplary processing device according to the present disclosure.

FIG. 2A is a block diagram of topology of connections of an exemplary computing system according to the present disclosure.

FIG. 2B is a block diagram of topology of connections of another exemplary computing system according to the present disclosure.

FIG. 3A is a block diagram of an exemplary cluster according to the present disclosure.

FIG. 3B is a block diagram of an exemplary super cluster according to the present disclosure.

FIG. 4 is a block diagram of an exemplary processing engine according to the present disclosure.

FIG. 5 is a block diagram of an exemplary packet according to the present disclosure.

FIG. 6 is a flow diagram showing an exemplary process of addressing a computing resource using a packet according to the present disclosure.

FIG. 7A is a block diagram of an exemplary computing system with system control and monitoring features according to the present disclosure.

FIG. 7B is a block diagram of an exemplary processing device with system control and monitoring features according to the present disclosure.

FIG. 7C is a block diagram of an exemplary cluster with system control and monitoring features according to the present disclosure.

FIG. 7D is a block diagram of an exemplary super cluster with system control and monitoring features according to the present disclosure.

FIG. 8 illustrates a host configured to assign computation tasks in an exemplary computing system according to the present disclosure.

FIG. 9 is a flow diagram illustrating an exemplary process by which a computing system according to the present disclosure may adjust assignment of computing tasks to a plurality of computing resources of the computing system.

FIG. 10A illustrates a directed graph representation of a computing problem and/or a software application according to the present disclosure.

FIG. 10B illustrates a directed graph representation of a set of physical processing elements that corresponds to an implementation and/or assignment of a computing problem and/or a software application according to the present disclosure.

FIG. 10C illustrates a network of interconnected physical processing elements according to the present disclosure.

FIG. 11 is a block diagram illustrating an exemplary task re-assignment according to the present disclosure.

FIG. 12 is a block diagram illustrating another exemplary task re-assignment according to the present disclosure.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

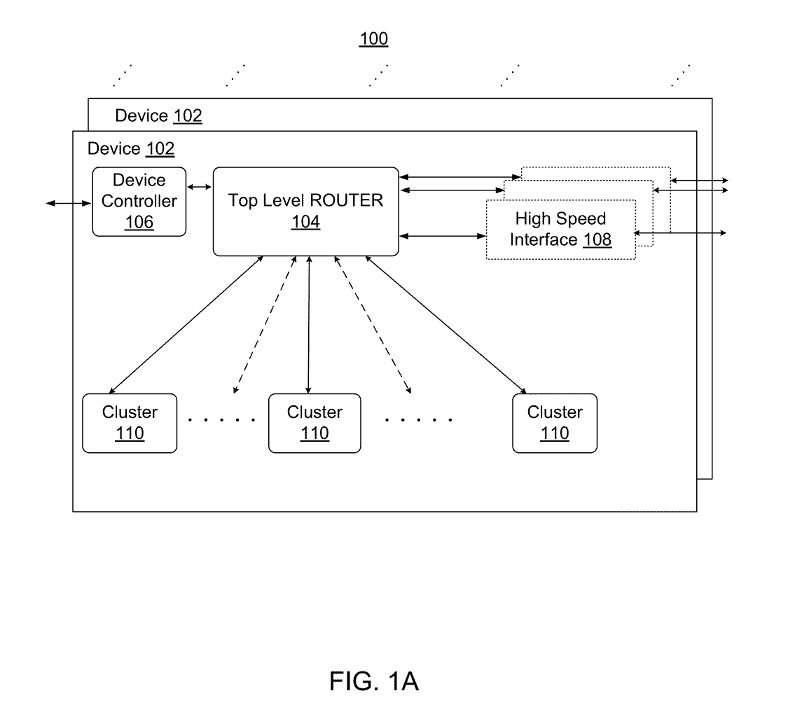

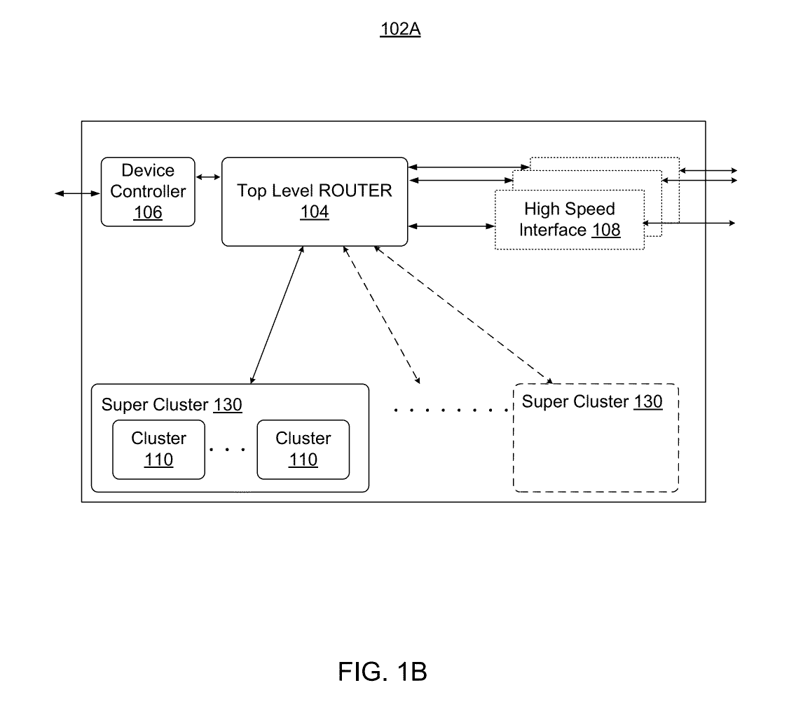

FIG. 1A shows an exemplary computing system 100 according to the present disclosure. The computing system 100 may comprise at least one processing device 102. A typical computing system 100, however, may comprise a plurality of processing devices 102. Each processing device 102, which may also be referred to as device 102, may comprise a router 104, a device controller 106, a plurality of high speed interfaces 108 and a plurality of clusters 110. The router 104 may also be referred to as a top level router or a level one router. Each cluster 110 may comprise a plurality of processing engines to provide computational capabilities for the computing system 100. The high speed interfaces 108 may comprise communication ports to communicate data outside of the device 102, for example, to other devices 102 of the computing system 100 and/or interfaces to other computing systems. Unless specifically expressed otherwise, data as used herein may refer to both program code and pieces of information upon which the program code operates.

In some implementations, the processing device 102 may include 2, 4, 8, 16, 32 or another number of high speed interfaces 108. Each high speed interface 108 may implement a physical communication protocol. In one non-limiting example, each high speed interface 108 may implement the media access control (MAC) protocol, and thus may have a unique MAC address associated with it. The physical communication may be implemented in a known communication technology, for example, Gigabit Ethernet, or any other existing or future-developed communication technology. In one non-limiting example, each high speed interface 108 may implement bi-directional high-speed serial ports, such as 10 Giga bits per second (Gbps) serial ports. Two processing devices 102 implementing such high speed interfaces 108 may be directly coupled via one pair or multiple pairs of the high speed interfaces 108, with each pair comprising one high speed interface 108 on one processing device 102 and another high speed interface 108 on the other processing device 102.

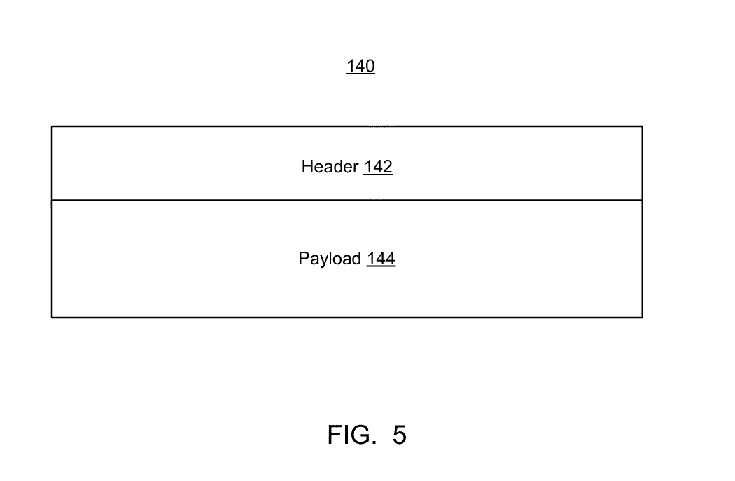

Data communication between different computing resources of the computing system 100 may be implemented using routable packets. The computing resources may comprise device level resources such as a device controller 106, cluster level resources such as a cluster controller or cluster memory controller, and/or the processing engine level resources such as individual processing engines and/or individual processing engine memory controllers. An exemplary packet 140 according to the present disclosure is shown in FIG. 5. The packet 140 may comprise a header 142 and a payload 144. The header 142 may include a routable destination address for the packet 140. The router 104 may be a top-most router configured to route packets on each processing device 102. The router 104 may be a programmable router. That is, the routing information used by the router 104 may be programmed and updated. In one non-limiting embodiment, the router 104 may be implemented using an address resolution table (ART) or Look-up table (LUT) to route any packet it receives on the high speed interfaces 108, or any of the internal interfaces interfacing the device controller 106 or clusters 110. For example, depending on the destination address, a packet 140 received from one cluster 110 may be routed to a different cluster 110 on the same processing device 102, or to a different processing device 102; and a packet 140 received from one high speed interface 108 may be routed to a cluster 110 on the processing device or to a different processing device 102.

The device controller 106 may control the operation of the processing device 102 from power on through power down. The device controller 106 may comprise a device controller processor, one or more registers and a device controller memory space. The device controller processor may be any existing or future-developed microcontroller. In one embodiment, for example, an ARM® Cortex M0 microcontroller may be used for its small footprint and low power consumption. In another embodiment, a bigger and more powerful microcontroller may be chosen if needed. The one or more registers may include one to hold a device identifier (DEVID) for the processing device 102 after the processing device 102 is powered up. The DEVID may be used to uniquely identify the processing device 102 in the computing system 100. In one non-limiting embodiment, the DEVID may be loaded on system start from a non-volatile storage, for example, a non-volatile internal storage on the processing device 102 or a non-volatile external storage. The device controller memory space may include both read-only memory (ROM) and random access memory (RAM). In one non-limiting embodiment, the ROM may store bootloader code that during a system start may be executed to initialize the processing device 102 and load the remainder of the boot code through a bus from outside of the device controller 106. The instructions for the device controller processor, also referred to as the firmware, may reside in the RAM after they are loaded during the system start.

The registers and device controller memory space of the device controller 106 may be read and written to by computing resources of the computing system 100 using packets. That is, they are addressable using packets. As used herein, the term “memory” may refer to RAM, SRAM, DRAM, eDRAM, SDRAM, volatile memory, non-volatile memory, and/or other types of electronic memory. For example, the header of a packet may include a destination address such as DEVID:PADDR, of which the DEVID may identify the processing device 102 and the PADDR may be an address for a register of the device controller 106 or a memory location of the device controller memory space of a processing device 102. In some embodiments, a packet directed to the device controller 106 may have a packet operation code, which may be referred to as packet opcode or just opcode to indicate what operation needs to be performed for the packet. For example, the packet operation code may indicate reading from or writing to the storage location pointed to by PADDR. It should be noted that the device controller 106 may also send packets in addition to receiving them. The packets sent by the device controller 106 may be self-initiated or in response to a received packet (e.g., a read request). Self-initiated packets may include for example, reporting status information, requesting data, etc.

In one embodiment, a plurality of clusters 110 on a processing device 102 may be grouped together. FIG. 1B shows a block diagram of another exemplary processing device 102A according to the present disclosure. The exemplary processing device 102A is one particular embodiment of the processing device 102. Therefore, the processing device 102 referred to in the present disclosure may include any embodiments of the processing device 102, including the exemplary processing device 102A. As shown on FIG. 1B, a plurality of clusters 110 may be grouped together to form a super cluster 130 and an exemplary processing device 102A may comprise a plurality of such super clusters 130. In one embodiment, a processing device 102 may include 2, 4, 8, 16, 32 or another number of clusters 110, without further grouping the clusters 110 into super clusters. In another embodiment, a processing device 102 may include 2, 4, 8, 16, 32 or another number of super clusters 130 and each super cluster 130 may comprise a plurality of clusters.

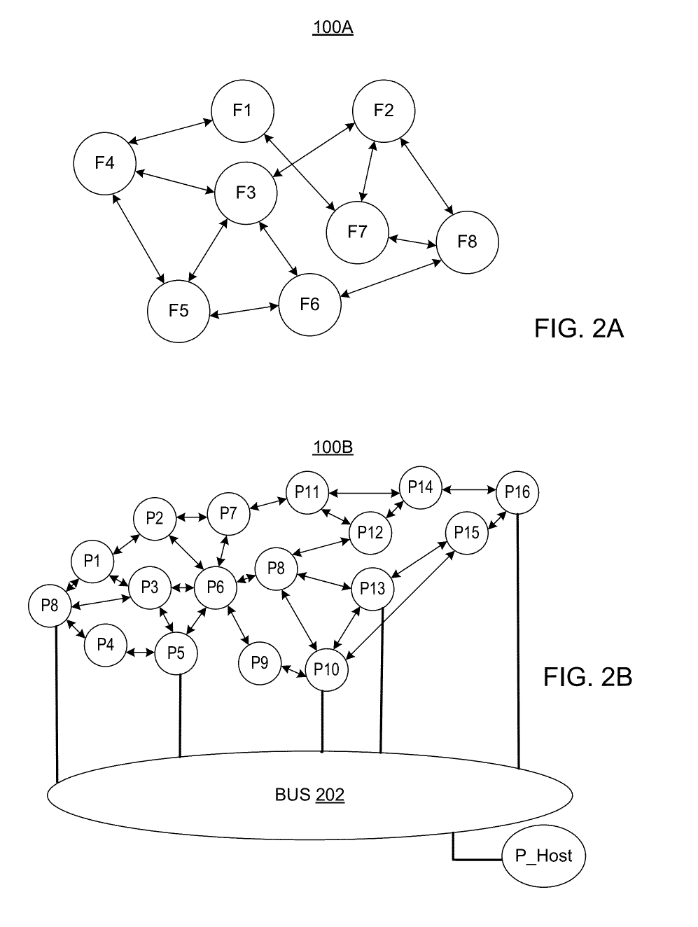

FIG. 2A shows a block diagram of an exemplary computing system 100A according to the present disclosure. The computing system 100A may be one exemplary embodiment of the computing system 100 of FIG. 1A. The computing system 100A may comprise a plurality of processing devices 102 designated as F1, F2, F3, F4, F5, F6, F7 and F8. As shown in FIG. 2A, each processing device 102 may be directly coupled to one or more other processing devices 102. For example, F4 may be directly coupled to F1, F3 and F5; and F7 may be directly coupled to F1, F2 and F8. Within computing system 100A, one of the processing devices 102 may function as a host for the whole computing system 100A. The host may have a unique device ID that every processing devices 102 in the computing system 100A recognizes as the host. For example, any processing devices 102 may be designated as the host for the computing system 100A. In one non-limiting example, F1 may be designated as the host and the device ID for F1 may be set as the unique device ID for the host.

In another embodiment, the host may be a computing device of a different type, such as a computer processor known in the art (for example, an ARM® Cortex or Intel® x86 processor) or any other existing or future-developed processors. In this embodiment, the host may communicate with the rest of the system 100A through a communication interface, which may represent itself to the rest of the system 100A as the host by having a device ID for the host.

The computing system 100A may implement any appropriate techniques to set the DEVIDs, including the unique DEVID for the host, to the respective processing devices 102 of the computing system 100A. In one exemplary embodiment, the DEVIDs may be stored in the ROM of the respective device controller 106 for each processing devices 102 and loaded into a register for the device controller 106 at power up. In another embodiment, the DEVIDs may be loaded from an external storage. In such an embodiment, the assignments of DEVIDs may be performed offline, and may be changed offline from time to time or as appropriate. Thus, the DEVIDs for one or more processing devices 102 may be different each time the computing system 100A initializes. Moreover, the DEVIDs stored in the registers for each device controller 106 may be changed at runtime. This runtime change may be controlled by the host of the computing system 100A. For example, after the initialization of the computing system 100A, which may load the pre-configured DEVIDs from ROM or external storage, the host of the computing system 100A may reconfigure the computing system 100A and assign different DEVIDs to the processing devices 102 in the computing system 100A to overwrite the initial DEVIDs in the registers of the device controllers 106.

FIG. 2B is a block diagram of a topology of another exemplary system 100B according to the present disclosure. The computing system 100B may be another exemplary embodiment of the computing system 100 of FIG. 1 and may comprise a plurality of processing devices 102 (designated as P1 through P16 on FIG. 2B), a bus 202 and a processing device P_Host. Each processing device of P1 through P16 may be directly coupled to another processing device of P1 through P16 by a direct link between them. At least one of the processing devices P1 through P16 may be coupled to the bus 202. As shown in FIG. 2B, the processing devices P8, P5, P10, P13, P15 and P16 may be coupled to the bus 202. The processing device P_Host may be coupled to the bus 202 and may be designated as the host for the computing system 100B. In the exemplary system 100B, the host may be a computer processor known in the art (for example, an ARM® Cortex or Intel® x86 processor) or any other existing or future-developed processors. The host may communicate with the rest of the system 100B through a communication interface coupled to the bus and may represent itself to the rest of the system 100B as the host by having a device ID for the host.

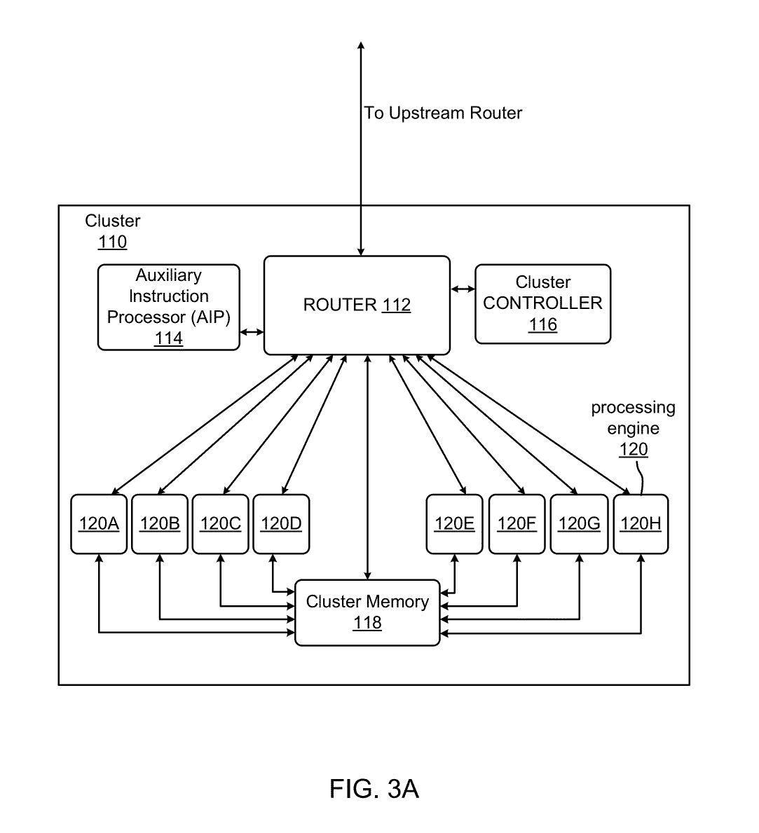

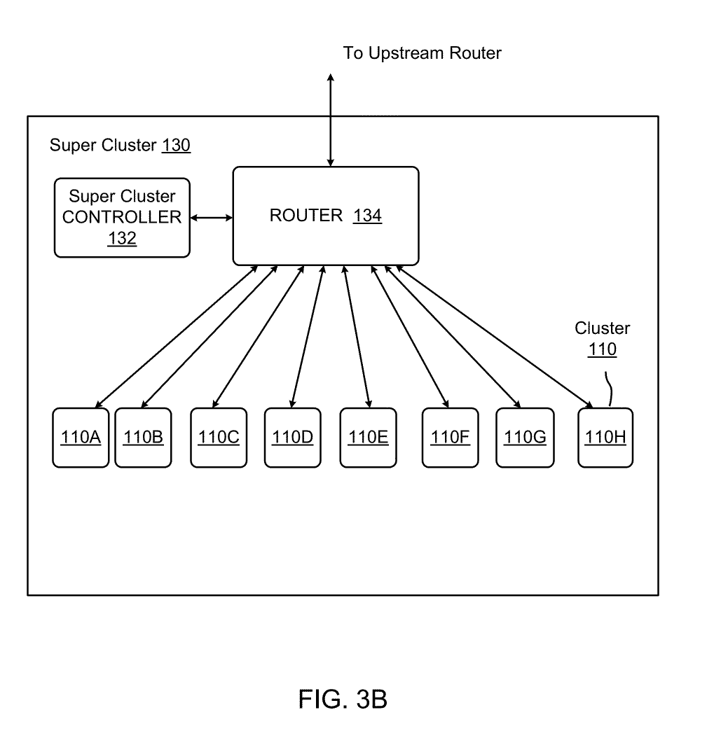

FIG. 3A shows a block diagram of an exemplary cluster 110 according to the present disclosure. The exemplary cluster 110 may comprise a router 112, a cluster controller 116, an auxiliary instruction processor (AIP) 114, a cluster memory 118 and a plurality of processing engines 120. The router 112 may be coupled to an upstream router to provide interconnection between the upstream router and the cluster 110. The upstream router may be, for example, the router 104 of the processing device 102 if the cluster 110 is not part of a super cluster 130.

The exemplary operations to be performed by the router 112 may include receiving a packet destined for a resource within the cluster 110 from outside the cluster 110 and/or transmitting a packet originating within the cluster 110 destined for a resource inside or outside the cluster 110. A resource within the cluster 110 may be, for example, the cluster memory 118 or any of the processing engines 120 within the cluster 110. A resource outside the cluster 110 may be, for example, a resource in another cluster 110 of the computer device 102, the device controller 106 of the processing device 102, or a resource on another processing device 102. In some embodiments, the router 112 may also transmit a packet to the router 104 even if the packet may target a resource within itself. In one embodiment, the router 104 may implement a loopback path to send the packet back to the originating cluster 110 if the destination resource is within the cluster 110.

The cluster controller 116 may send packets, for example, as a response to a read request, or as unsolicited data sent by hardware for error or status report. The cluster controller 116 may also receive packets, for example, packets with opcodes to read or write data. In one embodiment, the cluster controller 116 may be any existing or future-developed microcontroller, for example, one of the ARM® Cortex-M microcontroller and may comprise one or more cluster control registers (CCRs) that provide configuration and control of the cluster 110. In another embodiment, instead of using a microcontroller, the cluster controller 116 may be custom made to implement any functionalities for handling packets and controlling operation of the router 112. In such an embodiment, the functionalities may be referred to as custom logic and may be implemented, for example, by FPGA or other specialized circuitry. Regardless of whether it is a microcontroller or implemented by custom logic, the cluster controller 116 may implement a fixed-purpose state machine encapsulating packets and memory access to the CCRs.

Each cluster memory 118 may be part of the overall addressable memory of the computing system 100. That is, the addressable memory of the computing system 100 may include the cluster memories 118 of all clusters of all devices 102 of the computing system 100. The cluster memory 118 may be a part of the main memory shared by the computing system 100. In some embodiments, any memory location within the cluster memory 118 may be addressed by any processing engine within the computing system 100 by a physical address. The physical address may be a combination of the DEVID, a cluster identifier (CLSID) and a physical address location (PADDR) within the cluster memory 118, which may be formed as a string of bits, such as, for example, DEVID:CLSID:PADDR. The DEVID may be associated with the device controller 106 as described above and the CLSID may be a unique identifier to uniquely identify the cluster 110 within the local processing device 102. It should be noted that in at least some embodiments, each register of the cluster controller 116 may also be assigned a physical address (PADDR). Therefore, the physical address DEVID:CLSID:PADDR may also be used to address a register of the cluster controller 116, in which PADDR may be an address assigned to the register of the cluster controller 116.

In some other embodiments, any memory location within the cluster memory 118 may be addressed by any processing engine within the computing system 100 by a virtual address. The virtual address may be a combination of a DEVID, a CLSID and a virtual address location (ADDR), which may be formed as a string of bits, such as, for example, DEVID:CLSID:ADDR. The DEVID and CLSID in the virtual address may be the same as in the physical addresses.

In one embodiment, the width of ADDR may be specified by system configuration. For example, the width of ADDR may be loaded into a storage location convenient to the cluster memory 118 during system start and/or changed from time to time when the computing system 100 performs a system configuration. To convert the virtual address to a physical address, the value of ADDR may be added to a base physical address value (BASE). The BASE may also be specified by system configuration as the width of ADDR and stored in a location convenient to a memory controller of the cluster memory 118. In one example, the width of ADDR may be stored in a first register and the BASE may be stored in a second register in the memory controller. Thus, the virtual address DEVID:CLSID:ADDR may be converted to a physical address as DEVID:CLSID:ADDR+BASE. Note that the result of ADDR+BASE has the same width as the longer of the two.

The address in the computing system 100 may be 8 bits, 16 bits, 32 bits, 64 bits, or any other number of bits wide. In one non-limiting example, the address may be 32 bits wide. The DEVID may be 10, 15, 20, 25 or any other number of bits wide. The width of the DEVID may be chosen based on the size of the computing system 100, for example, how many processing devices 102 the computing system 100 has or may be designed to have. In one non-limiting example, the DEVID may be 20 bits wide and the computing system 100 using this width of DEVID may contain up to 2²⁰ processing devices 102. The width of the CLSID may be chosen based on how many clusters 110 the processing device 102 may be designed to have. For example, the CLSID may be 3, 4, 5, 6, 7, 8 bits or any other number of bits wide. In one non-limiting example, the CLSID may be 5 bits wide and the processing device 102 using this width of CLSID may contain up to 2⁵ clusters. The width of the PADDR for the cluster level may be 20, 30 or any other number of bits. In one non-limiting example, the PADDR for the cluster level may be 27 bits and the cluster 110 using this width of PADDR may contain up to 2²⁷ memory locations and/or addressable registers. Therefore, in some embodiments, if the DEVID may be 20 bits wide, CLSID may be 5 bits and PADDR may have a width of 27 bits, a physical address DEVID:CLSID:PADDR or DEVID:CLSID:ADDR+BASE may be 52 bits.

For performing the virtual to physical memory conversion, the first register (ADDR register) may have 4, 5, 6, 7 bits or any other number of bits. In one non-limiting example, the first register may be 5 bits wide. If the value of the 5 bits register is four (4), the width of ADDR may be 4 bits; and if the value of 5 bits register is eight (8), the width of ADDR will be 8 bits. Regardless of ADDR being 4 bits or 8 bits wide, if the PADDR for the cluster level may be 27 bits then BASE may be 27 bits, and the result of ADDR+BASE may still be a 27 bits physical address within the cluster memory 118.

FIG. 3A shows that a cluster 110 may comprise one cluster memory 118. In another embodiment, a cluster 110 may comprise a plurality of cluster memories 118 that each may comprise a memory controller and a plurality of memory banks, respectively. Moreover, in yet another embodiment, a cluster 110 may comprise a plurality of cluster memories 118 and these cluster memories 118 may be connected together via a router that may be downstream of the router 112.

The AIP 114 may be a special processing engine shared by all processing engines 120 of one cluster 110. In one example, the AIP 114 may be implemented as a coprocessor to the processing engines 120. For example, the AIP 114 may implement less commonly used instructions such as some floating point arithmetic, including but not limited to, one or more of addition, subtraction, multiplication, division and square root, etc. As shown in FIG. 3A, the AIP 114 may be coupled to the router 112 directly and may be configured to send and receive packets via the router 112. As a coprocessor to the processing engines 120 within the same cluster 110, although not shown in FIG. 3A, the AIP 114 may also be coupled to each processing engines 120 within the same cluster 110 directly. In one embodiment, a bus shared by all the processing engines 120 within the same cluster 110 may be used for communication between the AIP 114 and all the processing engines 120 within the same cluster 110. In another embodiment, a multiplexer may be used to control communication between the AIP 114 and all the processing engines 120 within the same cluster 110. In yet another embodiment, a multiplexer may be used to control access to the bus shared by all the processing engines 120 within the same cluster 110 for communication with the AIP 114.

The grouping of the processing engines 120 on a computing device 102 may have a hierarchy with multiple levels. For example, multiple clusters 110 may be grouped together to form a super cluster. FIG. 3B is a block diagram of an exemplary super cluster 130 according to the present disclosure. As shown on FIG. 3B, a plurality of clusters 110A through 110H may be grouped into an exemplary super cluster 130. Although 8 clusters are shown in the exemplary super cluster 130 on FIG. 3B, the exemplary super cluster 130 may comprise 2, 4, 8, 16, 32 or another number of clusters 110. The exemplary super cluster 130 may comprise a router 134 and a super cluster controller 132, in addition to the plurality of clusters 110. The router 134 may be configured to route packets among the clusters 110 and the super cluster controller 132 within the super cluster 130, and to and from resources outside the super cluster 130 via a link to an upstream router. In an embodiment in which the super cluster 130 may be used in a processing device 102A, the upstream router for the router 134 may be the top level router 104 of the processing device 102A and the router 134 may be an upstream router for the router 112 within the cluster 110. In one embodiment, the super cluster controller 132 may implement CCRs, may be configured to receive and send packets, and may implement a fixed-purpose state machine encapsulating packets and memory access to the CCRs, and the super cluster controller 132 may be implemented similar to the cluster controller 116. In another embodiment, the super cluster 130 may be implemented with just the router 134 and may not have a super cluster controller 132.

An exemplary cluster 110 according to the present disclosure may include 2, 4, 8, 16, 32 or another number of processing engines 120. FIG. 3A shows an example of a plurality of processing engines 120 that have been grouped into a cluster 110 and FIG. 3B shows an example of a plurality of clusters 110 that have been grouped into a super cluster 130. Grouping of processing engines is not limited to clusters or super clusters. In one embodiment, more than two levels of grouping may be implemented and each level may have its own router and controller.

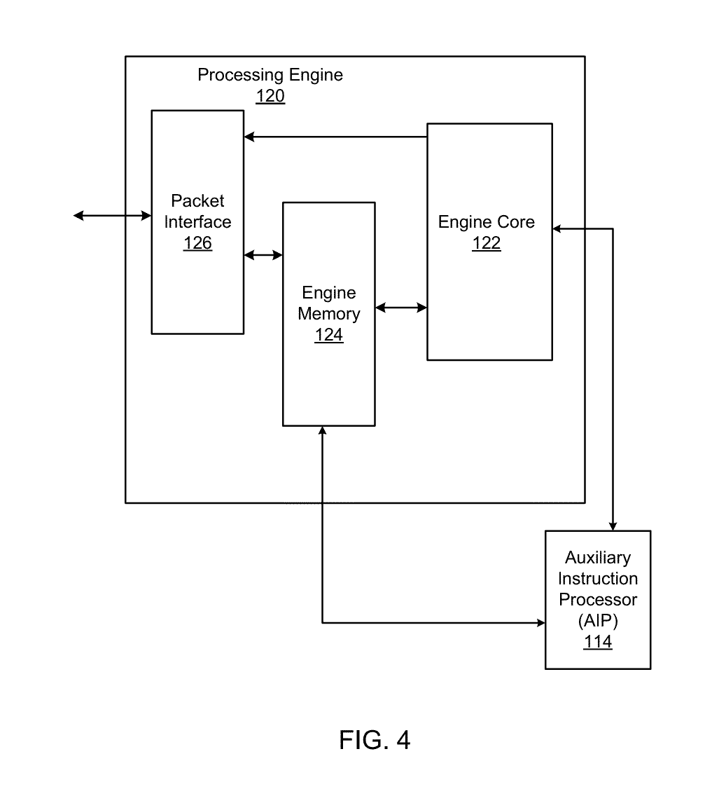

FIG. 4 shows a block diagram of an exemplary processing engine 120 according to the present disclosure. As shown in FIG. 4, the processing engine 120 may comprise an engine core 122, an engine memory 124 and a packet interface 126. The processing engine 120 may be coupled to an AIP 114. As described herein, the AIP 114 may be shared by all processing engines 120 within a cluster 110. The processing core 122 may be a central processing unit (CPU) with an instruction set and may implement some or all features of modern CPUs, such as, for example, a multi-stage instruction pipeline, one or more arithmetic logic units (ALUs), a floating point unit (FPU) or any other existing or future-developed CPU technology. The instruction set may comprise one instruction set for the ALU to perform arithmetic and logic operations, and another instruction set for the FPU to perform floating point operations. In one embodiment, the FPU may be a completely separate execution unit containing a multi-stage, single-precision floating point pipeline. When an FPU instruction reaches the instruction pipeline of the processing engine 120, the instruction and its source operand(s) may be dispatched to the FPU.

The instructions of the instruction set may implement the arithmetic and logic operations and the floating point operations, such as those in the INTEL® x86 instruction set, using a syntax similar or different from the x86 instructions. In some embodiments, the instruction set may include customized instructions. For example, one or more instructions may be implemented according to the features of the computing system 100. In one example, one or more instructions may cause the processing engine executing the instructions to generate packets directly with system wide addressing. In another example, one or more instructions may have a memory address located anywhere in the computing system 100 as an operand. In such an example, a memory controller of the processing engine executing the instruction may generate packets according to the memory address being accessed.

The engine memory 124 may comprise a program memory, a register file comprising one or more general purpose registers, one or more special registers and one or more events registers. The program memory may be a physical memory for storing instructions to be executed by the processing core 122 and data to be operated upon by the instructions. In some embodiments, portions of the program memory may be disabled and powered down for energy savings. For example, a top half or a bottom half of the program memory may be disabled to save energy when executing a program small enough that less than half of the storage may be needed. The size of the program memory may be 1 thousand (1K), 2K, 3K, 4K, or any other number of storage units. The register file may comprise 128, 256, 512, 1024, or any other number of storage units. In one non-limiting example, the storage unit may be 32-bit wide, which may be referred to as a longword, and the program memory may comprise 2K 32-bit longwords and the register file may comprise 256 32-bit registers.

The register file may comprise one or more general purpose registers for the processing core 122. The general purpose registers may serve functions that are similar or identical to the general purpose registers of an x86 architecture CPU.

The special registers may be used for configuration, control and/or status. Exemplary special registers may include one or more of the following registers: a program counter, which may be used to point to the program memory address where the next instruction to be executed by the processing core 122 is stored; and a device identifier (DEVID) register storing the DEVID of the processing device 102.

In one exemplary embodiment, the register file may be implemented in two banks—one bank for odd addresses and one bank for even addresses—to permit fast access during operand fetching and storing. The even and odd banks may be selected based on the least-significant bit of the register address for if the computing system 100 is implemented in little endian or on the most-significant bit of the register address if the computing system 100 is implemented in big-endian.

The engine memory 124 may be part of the addressable memory space of the computing system 100. That is, any storage location of the program memory, any general purpose register of the register file, any special register of the plurality of special registers and any event register of the plurality of events registers may be assigned a memory address PADDR. Each processing engine 120 on a processing device 102 may be assigned an engine identifier (ENGINE ID), therefore, to access the engine memory 124, any addressable location of the engine memory 124 may be addressed by DEVID:CLSID:ENGINE ID: PADDR. In one embodiment, a packet addressed to an engine level memory location may include an address formed as DEVID:CLSID:ENGINE ID: EVENTS:PADDR, in which EVENTS may be one or more bits to set event flags in the destination processing engine 120. It should be noted that when the address is formed as such, the events need not form part of the physical address, which is still DEVID:CLSID:ENGINE ID:PADDR. In this form, the events bits may identify one or more event registers to be set but these events bits may be separate from the physical address being accessed.

The packet interface 126 may comprise a communication port for communicating packets of data. The communication port may be coupled to the router 112 and the cluster memory 118 of the local cluster. For any received packets, the packet interface 126 may directly pass them through to the engine memory 124. In some embodiments, a processing device 102 may implement two mechanisms to send a data packet to a processing engine 120. For example, a first mechanism may use a data packet with a read or write packet opcode. This data packet may be delivered to the packet interface 126 and handled by the packet interface 126 according to the packet opcode. The packet interface 126 may comprise a buffer to hold a plurality of storage units, for example, 1K, 2K, 4K, or 8K or any other number. In a second mechanism, the engine memory 124 may further comprise a register region to provide a write-only, inbound data interface, which may be referred to a mailbox. In one embodiment, the mailbox may comprise two storage units that each can hold one packet at a time. The processing engine 120 may have a event flag, which may be set when a packet has arrived at the mailbox to alert the processing engine 120 to retrieve and process the arrived packet. When this packet is being processed, another packet may be received in the other storage unit but any subsequent packets may be buffered at the sender, for example, the router 112 or the cluster memory 118, or any intermediate buffers.

In various embodiments, data request and delivery between different computing resources of the computing system 100 may be implemented by packets. FIG. 5 illustrates a block diagram of an exemplary packet 140 according to the present disclosure. As shown in FIG. 5, the packet 140 may comprise a header 142 and an optional payload 144. The header 142 may comprise a single address field, a packet opcode (POP) field and a size field. The single address field may indicate the address of the destination computing resource of the packet, which may be, for example, an address at a device controller level such as DEVID:PADDR, an address at a cluster level such as a physical address DEVID:CLSID:PADDR or a virtual address DEVID:CLSID:ADDR, or an address at a processing engine level such as DEVID:CLSID:ENGINE ID:PADDR or DEVID:CLSID:ENGINE ID:EVENTS:PADDR. The POP field may include a code to indicate an operation to be performed by the destination computing resource. Exemplary operations in the POP field may include read (to read data from the destination) and write (to write data (e.g., in the payload 144) to the destination).

In some embodiments, the exemplary operations in the POP field may further include bulk data transfer. For example, certain computing resources may implement a direct memory access (DMA) feature. Exemplary computing resources that implement DMA may include a cluster memory controller of each cluster memory 118, a memory controller of each engine memory 124, and a memory controller of each device controller 106. Any two computing resources that implemented the DMA may perform bulk data transfer between them using packets with a packet opcode for bulk data transfer.

In addition to bulk data transfer, in some embodiments, the exemplary operations in the POP field may further include transmission of unsolicited data. For example, any computing resource may generate a status report or incur an error during operation, the status or error may be reported to a destination using a packet with a packet opcode indicating that the payload 144 contains the source computing resource and the status or error data.

The POP field may be 2, 3, 4, 5 or any other number of bits wide. In some embodiments, the width of the POP field may be selected depending on the number of operations defined for packets in the computing system 100. Also, in some embodiments, a packet opcode value can have different meaning based on the type of the destination computer resources that receives it. By way of example and not limitation, for a three-bit POP field, a value 001 may be defined as a read operation for a processing engine 120 but a write operation for a cluster memory 118.

In some embodiments, the header 142 may further comprise an addressing mode field and an addressing level field. The addressing mode field may contain a value to indicate whether the single address field contains a physical address or a virtual address that may need to be converted to a physical address at a destination. The addressing level field may contain a value to indicate whether the destination is at a device, cluster memory or processing engine level.

The payload 144 of the packet 140 is optional. If a particular packet 140 does not include a payload 144, the size field of the header 142 may have a value of zero. In some embodiments, the payload 144 of the packet 140 may contain a return address. For example, if a packet is a read request, the return address for any data to be read may be contained in the payload 144.

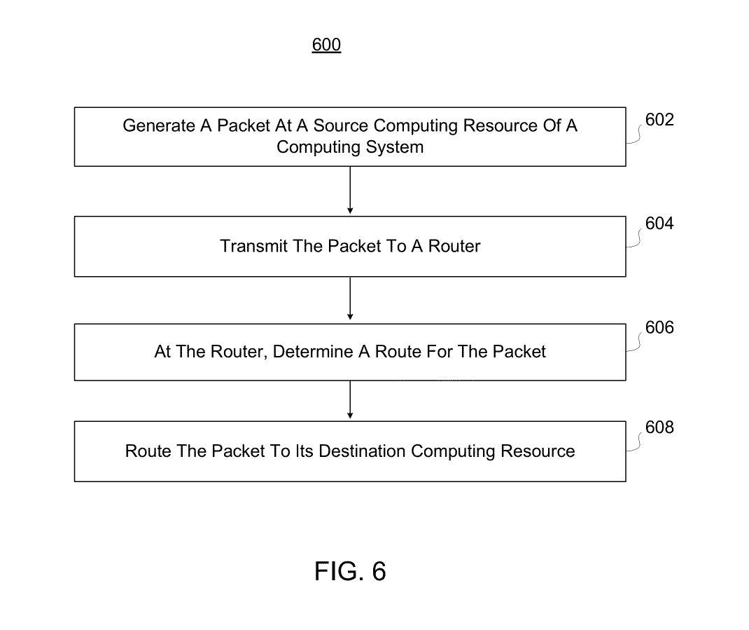

FIG. 6 is a flow diagram showing an exemplary process 200 of addressing a computing resource using a packet according to the present disclosure. An exemplary embodiment of the computing system 100 may have one or more processing devices configured to execute some or all of the operations of exemplary process 600 in response to instructions stored electronically on an electronic storage medium. The one or more processing devices may include one or more devices configured through hardware, firmware, and/or software to be specifically designed for execution of one or more of the operations of exemplary process 600.

The exemplary process 600 may start with block 602, at which a packet may be generated at a source computing resource of the exemplary embodiment of the computing system 100. The source computing resource may be, for example, a device controller 106, a cluster controller 118, a super cluster controller 132 if super cluster is implemented, an AIP 114, a memory controller for a cluster memory 118, or a processing engine 120. The generated packet may be an exemplary embodiment of the packet 140 according to the present disclosure. From block 602, the exemplary process 600 may continue to the block 604, where the packet may be transmitted to an appropriate router based on the source computing resource that generated the packet. For example, if the source computing resource is a device controller 106, the generated packet may be transmitted to a top level router 104 of the local processing device 102; if the source computing resource is a cluster controller 116, the generated packet may be transmitted to a router 112 of the local cluster 110; if the source computing resource is a memory controller of the cluster memory 118, the generated packet may be transmitted to a router 112 of the local cluster 110, or a router downstream of the router 112 if there are multiple cluster memories 118 coupled together by the router downstream of the router 112; and if the source computing resource is a processing engine 120, the generated packet may be transmitted to a router of the local cluster 110 if the destination is outside the local cluster and to a memory controller of the cluster memory 118 of the local cluster 110 if the destination is within the local cluster.

At block 606, a route for the generated packet may be determined at the router. As described herein, the generated packet may comprise a header that includes a single destination address. The single destination address may be any addressable location of a uniform memory space of the computing system 100. The uniform memory space may be an addressable space that covers all memories and registers for each device controller, cluster controller, super cluster controller if super cluster is implemented, cluster memory and processing engine of the computing system 100. In some embodiments, the addressable location may be part of a destination computing resource of the computing system 100. The destination computing resource may be, for example, another device controller 106, another cluster controller 118, a memory controller for another cluster memory 118, or another processing engine 120, which is different from the source computing resource. The router that received the generated packet may determine the route for the generated packet based on the single destination address. At block 608, the generated packet may be routed to its destination computing resource.

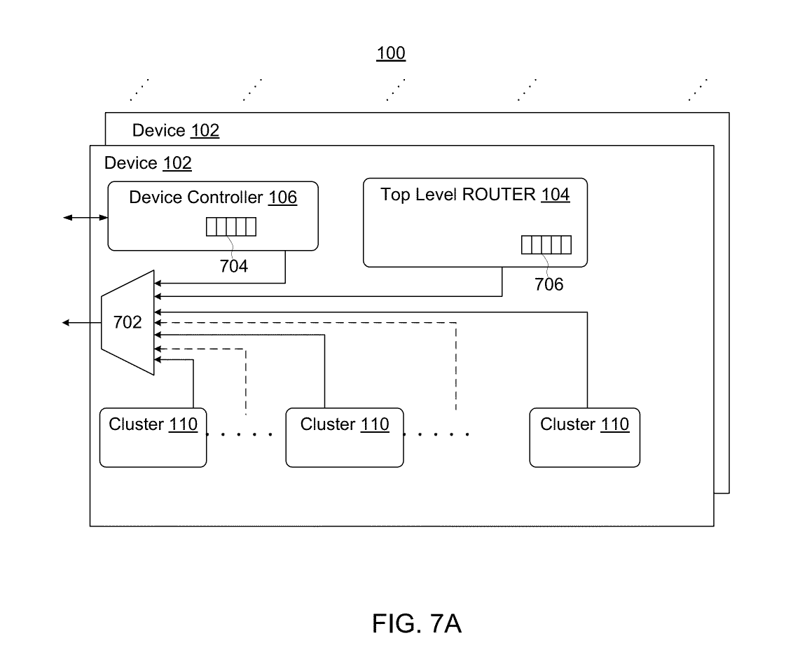

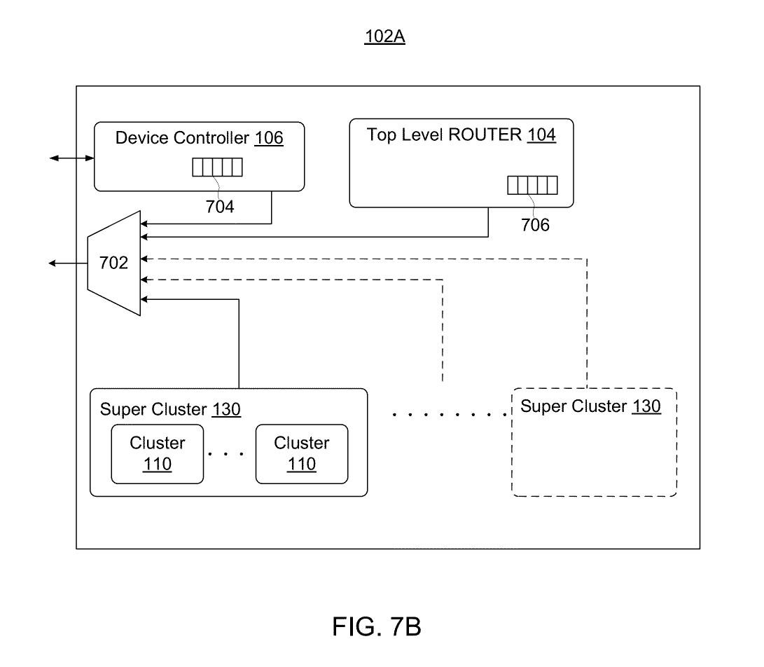

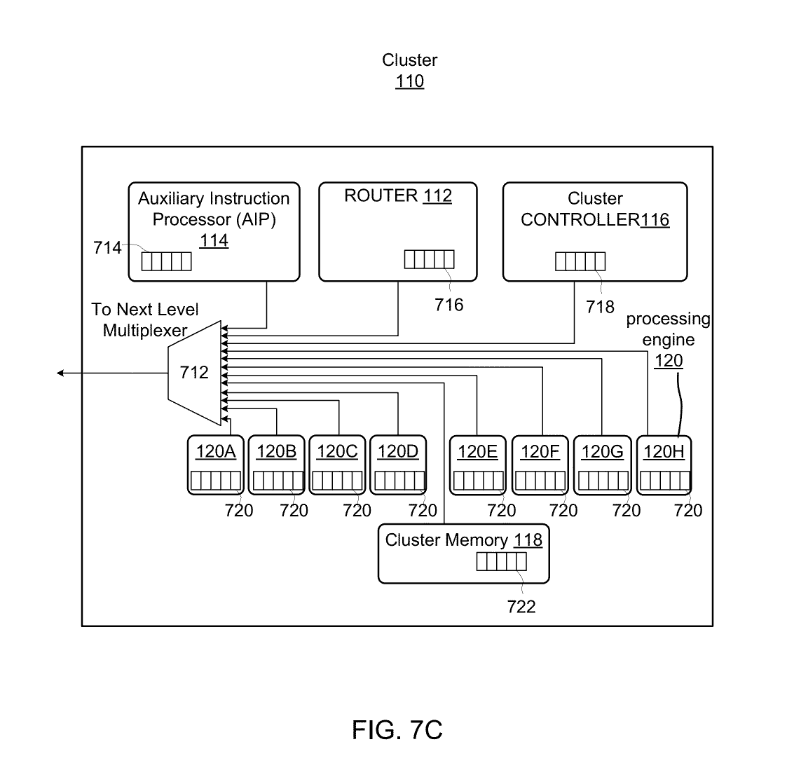

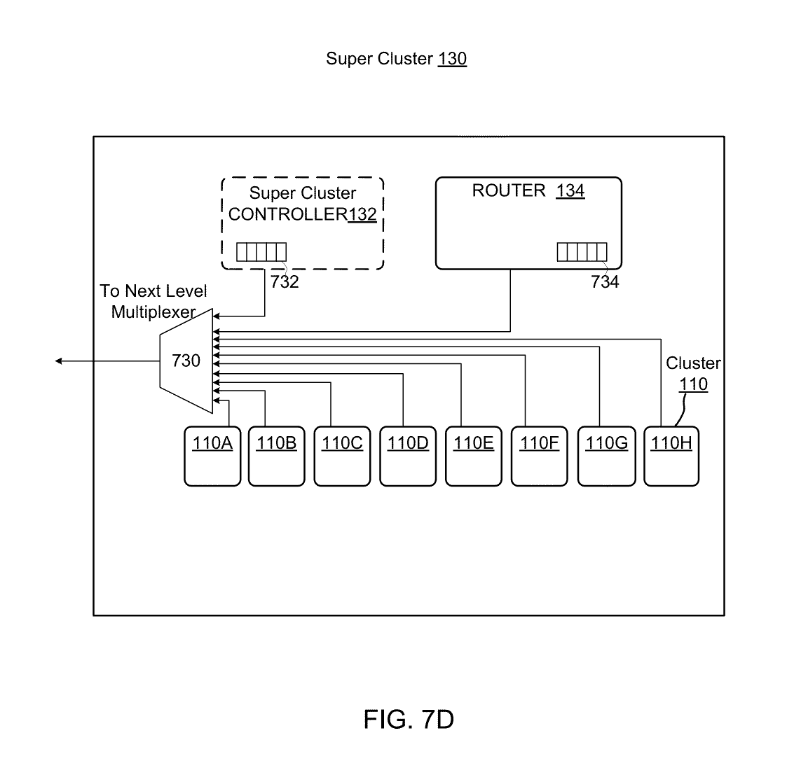

Each processing device 102 may also implement a system control and monitoring functionality. FIG. 7A shows the exemplary computing system 100 with system activity monitoring (SAM) features implemented at the processing device level according to the present disclosure. FIG. 7B shows an exemplary processing device 102A with system control and monitoring features according to the present disclosure. As shown on FIG. 7A, each processing device 102 may implement SAM features at the processing device level. The device level SAM features may comprise a SAM instrument 704 for the device controller 106, a SAM instrument 706 for the top level router 104, and a multiplexer 702. The multiplexer 702 may be configured to output SAM data from the processing device 102. The SAM data may be collected by the SAM instruments 704, 706, and SAM instruments within a cluster and super cluster (if the super cluster is implemented). The inputs of the multiplexer 702 may be coupled to the device controller 106, top level router 104, and clusters 110 (or super clusters 130 as shown in FIG. 7B if super clusters are implemented) to receive SAM data and may be controlled to select one of the SAM data inputs to output from the processing device 102. In one embodiment, a host of the computing system 100 may control the SAM data to output from the multiplexer 702 and the host may collect the SAM data from all processing devices 102 for analysis.

FIG. 7C shows an exemplary cluster 110 with SAM features according to the present disclosure. As shown on FIG. 7C, the exemplary cluster 110 may comprise a multiplexer 712, a SAM instrument 714 for the AIP 114, a SAM instrument 716 for the router 112, a SAM instrument 718 for the cluster controller 116, a SAM instrument 722 for the cluster memory 118, and a SAM instrument 720 for each of the processing engines 120 respectively. The SAM data of the exemplary cluster 110 may be collected by the SAM instruments 714, 716, 718, 720 and 722 within the cluster 110. The inputs of the multiplexer 712 may be coupled to the AIP 114, router 112, cluster controller 116, cluster memory 118 and all processing engines 120 to receive SAM data and may be controlled to select one of the SAM data inputs to output from the cluster 110. In one embodiment, a host of the computing system 100 may control the SAM data to output from the multiplexer 712 and propagate to the next level multiplexer. For example, in a processing device 102 without a super cluster, the next level multiplexer for the multiplexer 712 may be the multiplexer 702.

FIG. 7D shows an exemplary super cluster 130 with SAM features according to the present disclosure. The SAM features of the exemplary super cluster 130 may comprise a multiplexer 730, a SAM instrument 732 for the super cluster controller 132 and a SAM instrument 734 for the router 134. The multiplexer 730 may be the next level multiplexer for the multiplexers 712 within the clusters 110A through 110H. The inputs of the multiplexer 730 may be coupled to the super cluster controller 132, the router 134 and clusters 110A through 110H to receive SAM data and may be controlled to select one of the SAM data inputs to output from the super cluster 130. In one embodiment, a host of the computing system 100 may control the SAM data to output from the multiplexer 730 and propagate to the next level multiplexer. For example, in a processing device 102 with one level of super clusters, the next level multiplexer may be the multiplexer 702. It should be noted that the super cluster controller 132 may be optional, and in one embodiment the super cluster controller 132 may not be implemented and thus is shown in dashed lines.

Each of the SAM instruments 704, 706, 714, 716, 718, 720, 722, 732 and 734 may include one or more counters, one or more registers, and/or some non-volatile storage (for example, a plurality of registers or flash memory), respectively. Exemplary counters may include, but not limited to, a counter counting how many packets have been sent by a computing resource and/or how many packets have been received by a computing resource. Exemplary registers may be include, but not limited to, a register storing a programmable threshold of time for a counting period for a SAM counter. Exemplary usage of a non-volatile storage may include, but not limited to, storing a programmable threshold of time for a counting period for a SAM counter (e.g., to be used during system start up). Although not shown, an exemplary processing device 102 may comprise other SAM instruments, for example, signal lines for controlling the multiplexers 702, 712 and 730, registers that may at least temporarily save some configuration parameters for SAM instruments 704, 706, 714, 716, 718, 720, 722, 732 and 734, and multiplexers 702, 712 and 730.

In one embodiment, for example, one or more counters of an exemplary SAM instrument 706 may be used to count how many packets may be received at an ingress port during a beginning time and an end time, how many packets may be sent to an egress port during a beginning time and an end time, and/or how many packets may be received from (or sent to) an internal port coupled to a cluster 110 (or a super cluster 130 if the super cluster is implemented) during a beginning time and an end time, etc. The information collected by the counters may also include, for example, the identity of the destination computing resource and/or the identity of the sender computing resource. Each of the destination and/or sender computer resources may be a cluster 110 (or super cluster 130 if the super cluster is implemented) or the device controller 106 on the processing device 102, or another processing device 102. The ports to be monitored, the beginning and end times, and any additional information to be collected, may be programmable. In one embodiment, the parameters specifying the information needed to be collected by the counters may be programmed in the registers of the SAM instrument 706 at run time and may be capable of being updated from time to time. For example, a host of the computing system 100 may send instructions to a processing device 102 to program the SAM instruments on the processing device 102. The instructions may contain the parameters for information to be collected and may be sent from time to time.

The communications for the SAM data, such as the one-directional links in FIGS. 7A, 7B, 7C, and 7D, may be a data path separate from the data path for packet delivery. In one embodiment, the multiplexers 702, 712 and 730 may be controlled to select which SAM data to output. For example, at any time during the operation of the computing system 100, the multiplexers 702, 712 and 730 may be controlled to output SAM data from certain processing engine(s), cluster(s), super cluster(s) (if implemented) or processing device(s). In another embodiment, the multiplexers may be controlled to rotate through all processing engine(s), cluster(s), super cluster(s) (if implemented) or processing device(s), for example, in a round-robin manner. In one embodiment, SAM data may be aggregated by a host of the computing system 100 so that the host may generate a holistic view of activities and performance for the computing system 100 at or near real time. The performance information may be used by the host to diagnose system performance. For example, the host may implement hardware and/or software to collect and analyze the performance information from all processing engines, all clusters, all super clusters (if they are implemented) and all processing devices of the computing system 100. In addition to performance analysis, the SAM data may also help with hardware debug, software debug, runtime debug, in-device performance analysis and cross-device performance analysis.

Although the SAM instruments 704, 706, 714, 716, 718, 720, 732 and 734 are shown with their respective computing resources device controller 106, top level router 104, AIP 114, router 112, cluster controller 116, processing engine 120, super cluster controller 132 and router 134, in one embodiment, these SAM instruments may be located outside their respective computing resources. In such an embodiment, the inputs to the multiplexers 702, 712 and 730 may be coupled to those SAM instruments directly without being coupled to the respective computing resources.

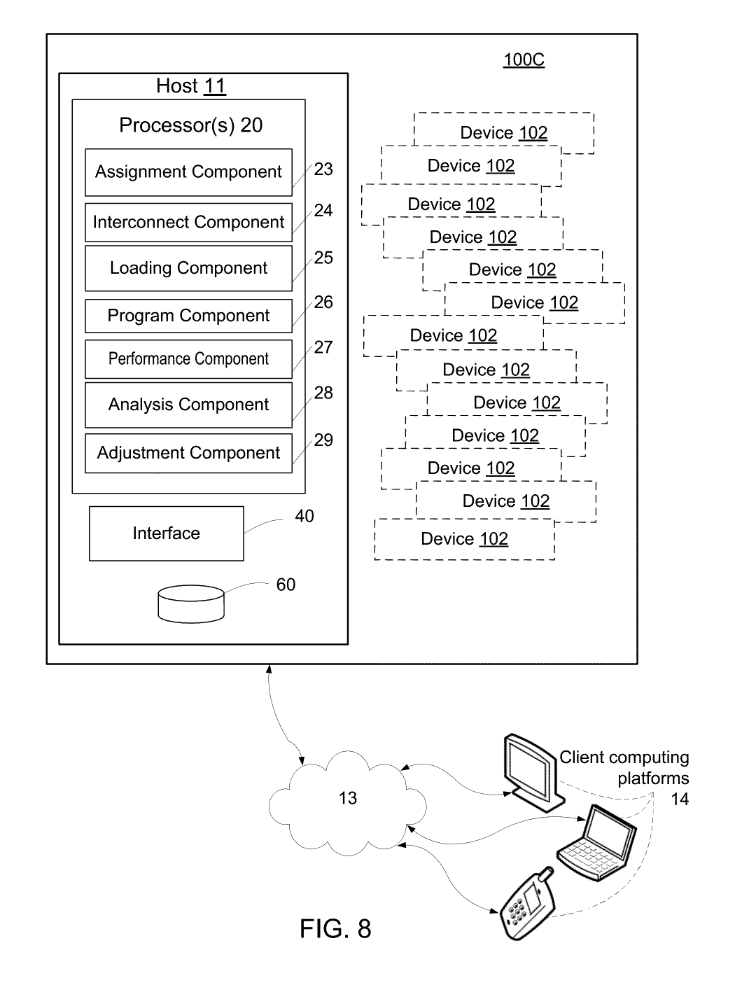

FIG. 8 illustrates an exemplary host 11 configured to assign computation tasks in an exemplary computing system 100C according to the present disclosure. The exemplary computing system 100C may be an example of the computing system 100 and may implement all features of the computing system 100 described herein. The host 11 may be an example of a host for the computing system 100 and may implement all features of a host of the computing system 100 described herein. As depicted in FIG. 8, the computing system 100C may comprise a plurality of processing devices 102 in addition to the host 11. The number of processing devices 102 may be as low as a couple or as high as hundreds of thousands, or even higher limited only by the width of DEVID. The exact number of processing devices 102 is immaterial and thus, the processing devices 102 are shown in phantom. The host 11 may comprise one or more processors 20, a physical storage 60, and an interface 40. In one embodiment, the topology and/or interconnections within the computing system 100C may be fixed. In another embodiment, the topology and/or interconnections within the computing system 100C may be programmable.

Interface 40 may be configured to provide an interface between the computing system 100C and a user (e.g., a system administrator) through which the user can provide and/or receive information. This enables data, results, and/or instructions and any other communicable items, collectively referred to as “information,” to be communicated between the user and the computing system 100C. Examples of interface devices suitable for inclusion in interface 40 include a keypad, buttons, switches, a keyboard, knobs, levers, a display screen, a touch screen, speakers, a microphone, an indicator light, an audible alarm, and a printer. Information may be provided by interface 40 in the form of auditory signals, visual signals, tactile signals, and/or other sensory signals.

It is to be understood that other communication techniques, either hard-wired or wireless, are also contemplated herein as interface 40. For example, in some implementations, interface 40 may be integrated with physical storage 60. In this example, information is loaded into computing system 100C from storage (e.g., a smart card, a flash drive, a removable disk, etc.) that enables the user(s) to customize the implementation of computing system 100C. Other exemplary input devices and techniques adapted for use with computing system 100C as interface 40 include, but are not limited to, an RS-232 port, RF link, an IR link, modem (telephone, cable, Ethernet, internet or other). In short, any technique for communicating information with computing system 100C is contemplated as interface 40.

One or more processors 20 (interchangeably referred to herein as processor 20) may be configured to execute computer program components. The computer program components may include an assignment component 23, an interconnect component 24, a loading component 25, a program component 26, a performance component 27, an analysis component 28, an adjustment component 29, and/or other components. The functionality provided by components 23-29 may be attributed for illustrative purposes to one or more particular components of computing system 100C. This is not intended to be limiting in any way, and any functionality may be provided by any component or entity described herein.

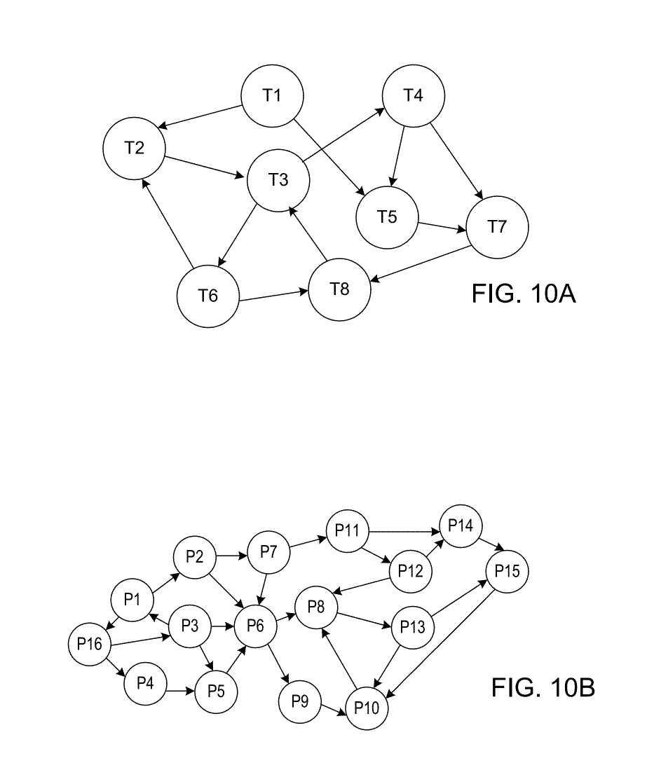

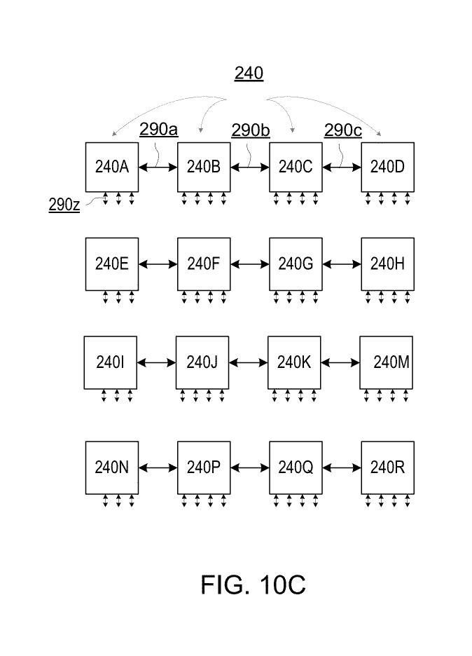

The functionality provided by components 23-29 may be used to load and execute one or more computer applications, including but not limited to one or more computer test applications, one or more computer web server applications, or one or more computer database management applications. For example, an application could include software-defined radio (SDR) or some representative portion thereof. For example, a test application could be based on an application such as SDR, for example by scaling down the scope to make testing easier and/or faster. Other applications are considered within the scope of this disclosure. By way of non-limiting example, a SDR application may include one or more of a mixer, a filter, an amplifier, a modulator, a demodulator, a detector, and/or other tasks and/or components that, when interconnected, may form an application. By way of non-limiting example, FIG. 10A illustrates a computing problem and/or an application that includes a set of functional processing elements that form a directed graph representation. The functional processing elements may be labeled T1-T8. Directional links within the directed graph may represent data exchange between functional processing elements. The set of functional processing elements as depicted in FIG. 10A may correspond to a set of interconnected tasks. In one embodiment, such division of tasks may be created by software programmers when one or more modules may be created for a software application.

Assignment component 23 may be configured to assign one or more computing resources within the computing system 100C to perform one or more tasks. The computing resources that may be assigned tasks may include processing devices 102, clusters 110, super clusters 130 (if super clusters are implemented), and/or processing engines 120. In some implementations, assignment component 23 may be configured to perform assignments in accordance with and/or based on a particular routing. For example, a routing may limit the number of processing devices 102 and/or processing engines 120 that are directly connected to a particular processing engine 120. In some implementations, by way of non-limiting example, the routing of a network of processing devices 102 may be fixed (i.e. the hardware connections between different processing devices 102 may be fixed), but the assignment of particular tasks to specific computing resources may be refined, improved, and/or optimized in pursuit of higher performance. In some implementations, by way of non-limiting example, the routing of a network of processing engines 102 may not be fixed (i.e. programmable between iterations of performing an assignment and determining the performance of a particular assignment), and the assignment of particular tasks to specific processing devices 102 and/or processing engines 120 may be also be adjusted, e.g. in pursuit of higher performance.

Assignment component 23 may be configured to determine and/or perform assignments repeatedly, e.g. in the pursuit of higher performance. As used herein, any association (or correspondence) involving applications, processing resources, tasks, and/or other entities related to the operation of a computing system 100C described herein, may be a one-to-one association, a one-to-many association, a many-to-one association, and/or a many-to-many association or N-to-M association (note that N and M may be different numbers greater than 1). For example, assignment component 23 may assign one or more computing resources to perform the task of one or more mixers of an SDR application. By way of non-limiting example, FIG. 10B illustrates a set of physical processing elements that form a directed graph representation that corresponds to a computing problem and/or a software application the same as or similar to the depiction in FIG. 10A. Referring to FIG. 10B, the physical processing elements are labeled P1-P16 as depicted. In one embodiment, the physical processing elements may correspond to processing devices 102. In another embodiment, the physical processing elements may correspond to processing engines 120. In yet another embodiment, the physical processing elements may correspond to clusters 110. In still another embodiment, the physical processing elements may correspond to super clusters 130 if super clusters are implemented. Combinations including one or more processing engines 120, clusters 110, super clusters 130, and one or more processing devices 102 may be envisioned within the scope of this disclosure. Referring to FIG. 10B, directional links within the directed graph may represent data exchange and/or a physical communication connection between physical processing elements. The set of physical processing elements as depicted in FIG. 10B may correspond to a set of processing engines 120, clusters 110, super clusters 130 (if super clusters are implemented) and/or processing devices 102 as assigned by assignment component 23.

Interconnect component 24 may be configured to obtain and/or determine interconnections between the physical processing elements to support an assignment by assignment component 23. A set of determined interconnections may be referred to as a routing. In one embodiment, interconnect component 24 may be configured to determine interconnections between individual ones of a set of computing resources such that interconnections and/or relations among a set of interconnected tasks correspond to an assignment by assignment component 23.

By way of non-limiting example, FIG. 10C illustrates physical processing elements that form a network that corresponds to a set of interconnections that support an assignment of a set of physical processing elements the same as or similar to the depiction in FIG. 10B. Referring to FIG. 10C, the set of physical processing elements is labeled 240 and the individual physical processing elements are labeled 240A-240R, as depicted. In some implementations, the physical processing elements may correspond to processing devices 102, clusters 110, super clusters 130 (if super clusters are implemented), processing engines 120, and/or any combination thereof. Referring to FIG. 10C, arrows within the network (including but not limited to connections 290a, 290b, 290c, and 290z) may represent data exchange and/or a physical communication connection between physical processing elements. For example, connection 290a may represent communication between physical processing elements 240A and 240B, connection 290b may represent communication between physical processing elements 240B and 240C, connection 290c may represent communication between physical processing elements 240C and 240D, connection 290z may represent communication between physical processing elements 240A and another element depicted in FIG. 10C, and so forth for any arrows depicted in FIG. 10C. The set of physical processing elements as depicted in FIG. 10C may correspond to a set of interconnections as determined by interconnect component 24.

Returning to FIG. 8, loading component 25 may be configured to load and/or program state, functions and/or connections into computing system 100C and/or its components. State may include instructions, information regarding interconnections with other processing devices 102, clusters 110, super clusters 130 (if super clusters are implemented), and/or set of processing engines 120, and/or other information needed to execute a particular task. The instructions may include instructions the generate signals that are indicative of occurrences of particular events within processing engines 120, clusters 110, super clusters 130 (if super clusters are implemented), and/or processing devices 102. In some implementations, the state may be determined by program component 26. In some implementations, loading component 25 may be configured to load and/or program a set of processing engines 120, clusters 110, super clusters 130 (if super clusters are implemented), and/or processing devices 102, a set of interconnections, as determined by interconnect component 24, and/or additional functionality into computing system 100C. For example, additional functionality may include input processing, memory storage, data transfer within one or more processing devices 102, data transfer within one or more clusters 110 or super clusters 130, output processing, and/or other functionality. In some implementations, loading component 25 may be configured to execute (at least part of) applications, e.g. responsive to functions and/or connections being loaded into computing system 100C and/or its components.

Program component 26 may be configured to determine state for processing devices 102, clusters 110, super clusters 130 (if super clusters are implemented), and/or processing engines 120. The particular state for a particular cluster 110, super cluster 130 (if super clusters are implemented), or processing engine 120 may be in accordance with an assignment and/or routing from another component of system 100C. In some implementations, program component 26 may be configured to program and/or load instructions and/or state into one or more clusters 110, super clusters 130 (if super clusters are implemented), and/or processing engines 120. In some implementations, programming individual processing engines 120, clusters 110, super clusters 130 (if super clusters are implemented), and/or processing devices 102 may include setting and/or writing control registers, for example, CCRs for cluster controllers 116 and super cluster controllers 132, control registers within the device controller 106, or control registers within the processing engines 120.

Performance component 27 may be configured to determine performance parameters of computing system 100C, one or more processing devices 102, one or more clusters 110, one or more super clusters 130 (if super cluster is implemented), one or more processing engines 120, and/or other configurations or combinations of processing elements described herein. In some implementations, one or more performance parameters may indicate the performance of assignment, and/or routing as performed by assignment component 23, interconnect component 24, and/or other components. For example, one or more performance parameters may indicate (memory/computation/communication-) bottlenecks, speed, delays, and/or other characteristics of performance. In some implementations, performance may be associated with a particular application, e.g. a test application. In addition, other information being collected may include how often a computing resource may need to coordinate its processing with any other computing resources, the latency for communication between computing resources while they coordinate their respective processing, whether some computing resources may be idle while some other computing resources with assigned tasks may have to wait.

In some implementations, one or more performance parameters may be based on signals generated within and/or by one or more processing engines 120, one or more processing devices 102, one or more cluster controllers 116, one or more super cluster controllers 132, one or more various levels of routers, and/or other components of computing system 100C. For example, the generated signals may be indicative of occurrences or events within a particular component of computing system 100C, as described elsewhere herein. By virtue of the signaling mechanisms (e.g., SAM data collection) described in this disclosure, the performance of (different configurations of) multi-core processing systems may be monitored, determined, and/or compared.

Analysis component 28 may be configured to analyze performance parameters. In some implementations, analysis component 28 may be configured to compare performance of different configurations of multi-core processing systems, different ways to divide an application into a set of interconnected tasks by a programmer (or a compiler, or an assembler), different assignments by assignment component 23, different routings by interconnect component 24, and/or other different options used during the configuration, design, and/or operation of a multi-core processing system.

In some implementations, analysis component 28 may be configured to indicate a bottleneck and/or other performance issue in terms of memory access, computational load, and/or communication between multiple processing elements/engines. For example, one task may be loaded on a processing engine and executed on it. If the processing engine is kept busy (e.g., no event signal of idleness) for a predetermined amount of time, then the task may be identified as a computation intensive task and a good candidate to be executed in parallel, such as being executed in two or more processing engines. In another example, two processing engines may be assigned to execute some program code respectively (could be one task split between the two processing engines, or each processing engine executing one of two interconnected tasks). If each of the two processing engines spends more than a predetermined percentage of time (e.g., 10%, 20%, 30% or another percentage, which may be programmable) waiting on other processing engine (e.g., for data or an event signal), then the program code may be identified as communication intensive task(s) and a good candidate to be executed on a single processing engine, or moved to be closer (such as but not limited to, two processing engines in one cluster, two processing engines in one super cluster, or two processing engines in one processing device).

Adjustment component 29 may be configured to determine adjustments to the configuration, design, and/or operation of a multi-core processing system, e.g. based on an analysis carried out by analysis component 28. Adjustments may involve one or more of a different assignment by assignment component 23, a different routing by interconnect component 24, and/or other different options used during the configuration, design, and/or operation of a multi-core processing system. Adjustments may be guided by a user, by an algorithm that is based on one or more particular performance parameters, by heuristics based on general design principles, and/or by other ways to guide step-wise refinement of multi-core processing performance. In some implementations, one or more operations performed by the components of computing system 100C may be performed iteratively and/or repeatedly in order to find and/or determine higher levels of performance.

In some implementations, determination of adjustments may be based on a simulated annealing processes, which may also be referred to as a synthetic annealing process. In one embodiment, the adjustment component 29 may implement part or all functionalities of an exemplary simulated annealing process. For example, after an adjustment has been made, the performance data may be collected on the adjusted configuration and analyzed. If an adjustment has improved the performance, the adjustment may be kept and other adjustment may be tried. If an adjustment has not improved the performance, the adjustment may be rolled back. In one embodiment, this process may be repeated until one or more performance goals are achieved. The performance goals may include absolute requirements or may be relative. For example, an absolute requirement may specify a predetermined number of operations per second and a relative performance goal may be a number of consecutive iterations (e.g., 2, 3, 4, or more) that provide an improvement of less than a certain percentage (e.g., 5%, 10%, 15% or a different percentage).

Simulated annealing techniques may also be used in the exemplary simulated annealing processes according to the present disclosure. For example, in some cases, annealing may introduce noise (e.g. random assignments of a particular processing engine 120 or processing device 102 to a particular task) in order to avoid localized optimizations in pursuit of global optimizations (i.e. noise may be introduced to avoid a local performance maximum/optimum among a range of options in configuring, assigning, routing, etc. of computing system 100C). In some implementations, adjustments to an assignment and/or a routing may include merging two tasks from the set of interconnected tasks into one new task. In some implementations, adjustments to an assignment and/or a routing may include splitting an individual task from the set of interconnected tasks into two new tasks. In some implementations, adjustments to an assignment and/or routing may include swapping tasks between two processing engines.

Referring to FIG. 8, one or more processors 20 may be configured to provide information-processing capabilities in computing system 100C and/or host 11. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 8 as a single entity, this is for illustrative purposes only. In one embodiment, processor 20 may include a plurality of processing units. For example, each processor 20 may be a processing device 102 or a processor of a different type as described herein. These processing units may be physically located within the same physical apparatus, or processor 20 may represent processing functionality of a plurality of apparatuses operating in coordination (e.g., “in the cloud”, and/or other virtualized processing solutions).

It should be appreciated that although components 23-29, are illustrated in FIG. 8 as being co-located within a single processing unit, in implementations in which processor 20 includes multiple processing units, one or more of components 23-29 may be located remotely from the other components. The description of the functionality provided by the different components 23-29 described herein is for illustrative purposes, and is not intended to be limiting, as any of components 23-29 may provide more or less functionality than is described. For example, one or more of components 23-29 may be eliminated, and some or all of its functionality may be provided by other ones of components 23-29. As another example, processor 20 may be configured to execute one or more additional components that may perform some or all of the functionality attributed herein to one of components 23-29.

Physical storage 60 of computing system 100C in FIG. 8 may comprise electronic storage media that stores information. In some implementations, physical storage 60 may store representations of computer program components, including instructions that implement the computer program components. The electronic storage media of physical storage 60 may include one or both of system storage that is provided integrally (i.e., substantially non-removable) with host 11 and/or removable storage that is removably connectable to host 11 via, for example, a port (e.g., a USB port, a FIREWIRE port, etc.) or a drive (e.g., a disk drive, etc.). Physical storage 60 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), network-attached storage (NAS), and/or other electronically readable storage media. Physical storage 60 may include virtual storage resources, such as storage resources provided via a cloud and/or a virtual private network. Physical storage 60 may store software algorithms, information determined by processor 20, information received via client computing platforms 14, and/or other information that enable host 11 and computing system 100C to function properly. Physical storage 60 may be one or more separate components within system 100C, or physical storage 60 may be provided integrally with one or more other components of computing system 100C (e.g., processor 20).

Users may interact with system 100C through client computing platforms 14. By way of non-limiting example, client computing platforms may include one or more of a desktop computer, a laptop computer, a handheld computer, a NetBook, a Smartphone, a tablet, a mobile computing platform, a gaming console, a television, a device for streaming internet media, and/or other computing platforms. Interaction between the system 100C and client computing platforms may be supported by one or more networks 13, including but not limited to the Internet.

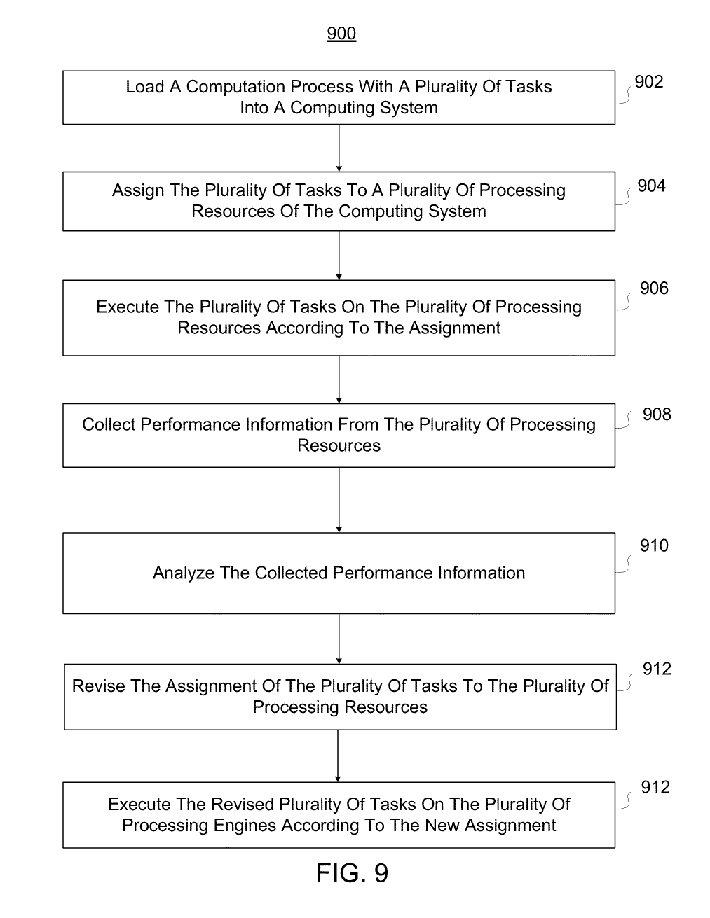

FIG. 9 is a flow diagram showing an exemplary process 900 for a computing system 100 to assign computing tasks to a plurality of computing resources of the computing system 100 according to the present disclosure. Each of the computing resources may be a processing engine 120, a cluster 110, a super cluster 130 (if super cluster is implemented) or a processing device 102. One example of computing system 100 configured to execute the exemplary process 900 may be the computing system 100C, in which the host 11 and other components of the computing system 100C may be configured through hardware, firmware, and/or software to be specifically designed for execution of one or more of the operations of exemplary process 900.

The exemplary process 900 may start with block 902, at which a computation process with a plurality of tasks may be loaded into an exemplary computing system 100C. For example, the computation process may be part of a computer application. Non-limiting examples of such a computer application may include a test application, a web server, and a database management system. For such examples, the computing process may be the computing process that a web server serves web pages on the Internet or a database management system provides data storage and/or data analysis. In one exemplary embodiment, the software application may comprise a plurality of modules that may be loaded and executed by separate physical processing elements. Non-limiting examples of such modules may include dynamic link libraries (DLLs), Java Archive (JAR) packages, and similar libraries on UNIX®, ANDROID® or MAC® operating systems. For example, for a web server application, the computing process of serving the web pages may include different tasks for authenticating users, for serving static web pages, and/or for generating dynamic web pages; for a database management system, the computing process of data analysis may include different tasks for querying databases and/or generating reports. An exemplary computing process including a plurality of tasks may be shown in FIG. 10A.

At block 904, the plurality of tasks may be assigned to a plurality of computing resources of the computing system. The assignment of tasks to computing resources may also be referred to as mapping. For example, one exemplary computing system 100C may comprise 10,000 processing devices 102 and each may comprise 256 processing engines 120 grouped in clusters, and the plurality of tasks may be assigned to the processing devices 102, clusters 110 and/or processing engines 120. If super clusters are implemented, the assignment may also be implemented at the super cluster level. In some embodiments, the program code being executed by the host 11 may assign the plurality of tasks across the processing devices, and deliver the tasks by packets addressed directly to the individual computing resource. FIG. 10B illustrates a plurality of computing resources P1 through P16 being assigned to execute the plurality of tasks. Each computing resources P1 through P16 may be assigned one task, duplicate of a task, or more than one task of FIG. 10A. Each of the computing resources P1 through P16 may be a processing device 102, a cluster 110, a super cluster 130 (if super cluster is implemented) or a processing engine 120.

At block 906, the plurality of tasks may be executed on the plurality of computing resources. As shown in FIG. 10B, the plurality of tasks may be executed on the computing resources P1 through P16. The directional links between the computing resources P1 through P16 may be communication channels between the computing resources. Although all of the channels are shown to be one-directional in FIG. 10B, it is within the scope of the present disclosure that some communication channels between some or all computing resources may be bi-directional.

At block 908, the performance information of the plurality of computing resources may be collected. As described herein, each processing devices 102 may collect SAM data at the device, cluster (and super cluster if super cluster is implemented), and processing engine levels. In some embodiments, while the plurality of computing resources are executing the tasks assigned to them, the host 11 may collect the performance information using the SAM data. For example, the performance component 27 may collect performance information from SAM instruments, including SAM counters, SAM registers, or both. In one embodiment, the plurality of tasks may be executed on the plurality of computing resources for a predetermined amount of time and the performance information may be collected for this predetermined amount of time, for example, a few milliseconds or up to a few minutes. In another embodiment, the performance information may be collected for an amount of time that is determined during operation. For example, once the plurality of tasks start to execute on the plurality of computing resources, there may be a spike of activity level on one or more routers for transmitting data to the plurality of computing resources. The activity level may be continuously monitored and the amount of time may be the period of time starting from the start of the spike until the activity level becomes steady. Steady may be determined, for example, as no substantial change (e.g., less than 5%, 10%, or 20%) over a predetermined time, such as 1 or 2 milliseconds, or 1 or 2 seconds.

At block 910, the collected performance information may be analyzed. For example, the analysis component 28 may perform analysis on the collected performance information. In one embodiment, the host 11 may collect SAM data prior to the tasks being assigned to and executed by the computing resources so that the host 11 may compare the SAM data for before and after assignment of the tasks to the computing resources as part of analysis.

At block 912, the assignment of the plurality of tasks to the plurality of computing resources may be revised. In one embodiment, based on the collected performance data, the host 11 may revise the mapping of the tasks to the processing resources. For example, the host 11 may determine that some tasks may be combined while some tasks (e.g., with multiple program modules) may be divided into smaller pieces (e.g., individual program modules or less modules in a software package).

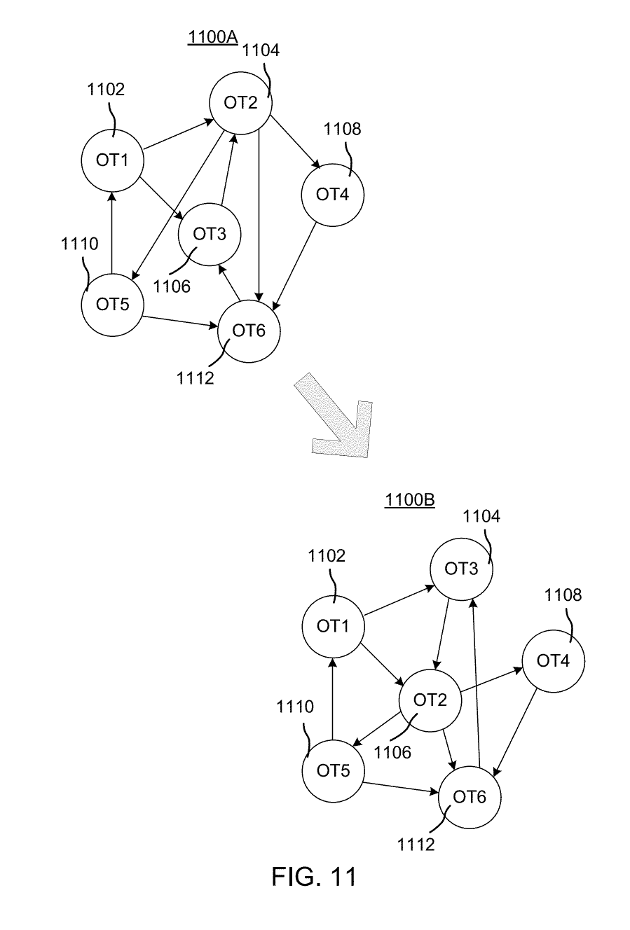

FIG. 11 illustrate an exemplary task re-assignment according to the present disclosure. An original mapping diagram 1100A shows that a plurality of computing resources 1102, 1104, 1106, 1108, 1110 and 1112 may originally be assigned tasks OT1 through OT6 to execute respectively. The revised mapping diagram 1100B shows the re-assignment of the tasks OT1 through OT6, in which the computing resources 1104 and 1106 may swap their assigned tasks OT2 and OT3. That is, the task OT2 now may be executed on the computing resource 1106 and the task OT3 may be executed on the computing resource 1102. Because the swap of the tasks between the computing resources 1104 and 1106, the directional links from and to the these two computing resources 1104 and 1106 may be affected as shown. Each of the computing resources 1102 through 1112 may be a processing engine 120, a cluster 110, a super cluster 130 (if super cluster is implemented), or a processing device 102.

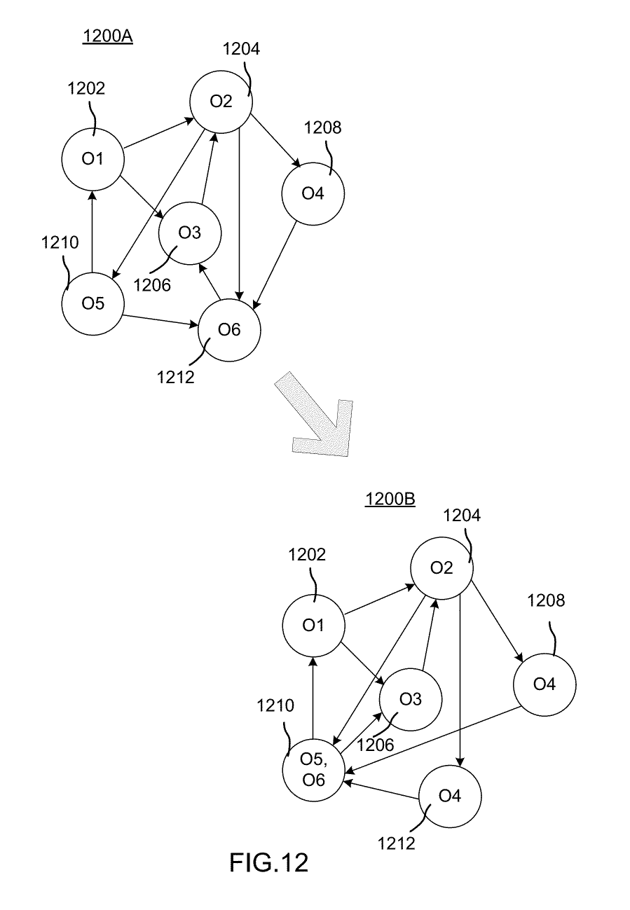

FIG. 12 illustrates another exemplary task re-assignment according to the present disclosure. An original mapping diagram 1200A shows that a plurality of computing resources 1202, 1204, 1206, 1208, 1210 and 1212 may originally be assigned tasks O1 through O6 to execute respectively. The re-assignment of the tasks O1 through O6 may be shown in the revised mapping diagram 1200B, in which both tasks O5 and O6 may be assigned to the computing resource 1210 and the task O4 may be assigned to both computing resources 1208 and 1212. Executing the tasks O5 and O6 together on a single computing resource may be useful, for example, if the tasks O5 and O6 exchange data frequently. Assigning the task O4 to two computing resources 1208 and 1212 may be achieved in a variety of ways. For example, the task O4 may be broken into parts and each part may be assigned to one computing resource, or alternatively, the task O4 may be duplicated and each duplicate copy may be assigned to one computing resource. Each of the computing resources 1202 through 1212 may be a processing engine 120, a cluster 110, a super cluster 130 (if super cluster is implemented), or a processing device 102.

Combining separate tasks to execute on a single computing resource may be referred to as a merge (or merger) of tasks and assigning one task to execute on multiple computing resources may be referred to as a split of a task. Although FIG. 12 shows one merge and one split being applied simultaneously, in various embodiments, merger and/or split of tasks may occur individually or in any combinations as appropriate to optimize the processing of the application. For example, in one embodiment, one or more merges may be used without any splits, and any of the merges may be a merger of two or more tasks. In another embodiment, one or more splits may be used without any merges, and any of the splits may be a split into two or more tasks. Moreover, when a merge may be applied, the merged tasks may be executed in any of the computing resource of the computing system, not necessarily one of the computing resource previously being used to carry out the execution of one of the merged tasks. That is, in some embodiments, the merged tasks O5 and O6 may be assigned to one of computing resources 1202 through 1208 or any other computing resources of the computing system. It should be noted that in one embodiment, a re-assignment of other tasks accompany the assignment of one merged task. Similarly, when a split occurs, the split task may be executed in any of the computing resources of the computing system, not necessarily one of the computing resources previously being used to carry out the execution of the split task or one of merged tasks (if any). That is, in some embodiments, the split task O4 may be assigned to any two computing resources of the computing resources 1202, 1204, 1206 and 1210, or any other computing resources of the computing system.

Referring back to FIG. 9, at block 914, the re-assigned plurality of tasks may be executed on the plurality of computing resources according to the new assignment. Using the collected SAM data, the computing system 100C may assign computation tasks dynamically and adaptively to the computing resources of the computing system 100C. In some embodiments, the blocks 908 through 912 may be repeated after the initial revision and reassignment of the tasks. Moreover, in some embodiments, the computing system 100C may implement features of simulated annealing process, such as but not limited to, rolling back adjustments if performance does not improve, and inject simulated noise to the collected SAM data. Therefore, embodiments of the computing system 100C may be robust and responsive to computing needs, and may offer great scalability to complex computer applications.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. A computer-implemented method for executing a software application on a computing system, the method comprising:
loading the software application into the computing system, the software application comprising a plurality of tasks;
assigning the plurality of tasks to a plurality of computing resources of the computing system according to a first assignment;
executing the plurality of tasks on the plurality of computing resources according to the first assignment, each processing resource being configured to generate and collect system activity monitoring (SAM) data;
collecting the SAM data from the plurality of processing resources;
performing an analysis of the first assignment based on the collected SAM data; and
determining an adjustment to the first assignment based on the analysis.

2. The method of claim 1, further comprising:
re-assigning the revised plurality of tasks to the plurality of computing resources according to a second assignment, wherein the second assignment is based on the determined adjustment to the first assignment; and
executing the plurality of tasks on the re-assigned plurality of processing resources.

3. The method of claim 2, further comprising:
iterating at least once the steps of executing the plurality of tasks based on a particular assignment, collecting SAM data, performing the analysis, determining a particular adjustment of the particular assignment, assigning the computing resources based on a revised assignment, and executing the plurality of tasks on the re-assigned plurality of processing resources.

4. The method of claim 1, wherein the computing system comprises a plurality of processing devices, each processing device comprises a plurality of processing engines grouped into one or more clusters, and each processing resource is one of a processing device, a cluster, or a processing engine and each processing resource implements a SAM instrument to generate and collect SAM data.

5. The method of claim 4, wherein a plurality of the one or more clusters are grouped into one or more super clusters and each processing resource is one of a processing device, a cluster, a super cluster or a processing engine, each super cluster also implements a SAM instrument to generate and collect SAM data.

6. The method of claim 1, wherein determining the adjustment to the first assignment is based on simulated annealing techniques.

7. The method of claim 1, wherein determining the adjustment to the first assignment includes introducing noise that is not based on the SAM data.

8. The method of claim 1, wherein the adjustment to the first assignment includes merging two tasks from the plurality of tasks into one new task.

9. The method of claim 1, wherein the adjustment to the first assignment includes splitting an individual task from the plurality of tasks into two new tasks.

10. The method of claim 1, wherein the first assignment includes a first processing resource being assigned to perform a first task and a second processing resource being assigned to perform a second task, and wherein the adjustment to the first assignment includes a swap of the first and second computing resources such that the first processing resource is assigned to perform the second task and the second processing resource is assigned to perform the first task.

11. A computing system configured to execute a plurality of tasks of a software application in parallel, comprising:
a plurality of computing resources configured to execute program code, each computing resource comprising a system activity monitoring (SAM) instrument configured to generate and collect SAM data; and
a host configured to:
load the software application into the computing system;
assign the plurality of tasks to the plurality of computing resources according to a first assignment;
execute the plurality of tasks on the plurality of computing resources according to the first assignment
collect the SAM data from the plurality of processing resources;
perform an analysis of the first assignment based on the collected SAM data; and
determine an adjustment to the first assignment based on the analysis.

12. The computing system of claim 11, wherein the host is further configured to:
re-assign the revised plurality of tasks to the plurality of computing resources according to a second assignment, wherein the second assignment is based on the determined adjustment to the first assignment; and
execute the plurality of tasks on the re-assigned plurality of processing resources.

13. The computing system of claim 12, wherein the host is further configured to:
iterate at least once the steps of executing the plurality of tasks based on a particular assignment, collecting SAM data, performing the analysis, determining a particular adjustment of the particular assignment, assigning the computing resources based on a revised assignment, and executing the plurality of tasks on the re-assigned plurality of processing resources.

14. The computing system of claim 11, wherein the computing system comprises a plurality of processing devices, each processing device comprises a plurality of processing engines grouped into one or more clusters, and each processing resource is one of a processing device, a cluster, or a processing engine.

15. The computing system of claim 14, wherein a plurality of the one or more clusters are grouped into one or more super clusters and each processing resource is one of a processing device, a cluster, a super cluster or a processing engine.

16. The computing system of claim 11, wherein determining the adjustment to the first assignment is based on simulated annealing techniques.

17. The computing system of claim 1, wherein to determine the adjustment to the first assignment includes to introduce noise that is not based on the SAM data.

18. The computing system of claim 11, wherein the adjustment to the first assignment includes merging two tasks from the plurality of tasks into one new task.

19. The computing system of claim 11, wherein the adjustment to the first assignment includes splitting an individual task from the plurality of tasks into two new tasks.

20. The computing system of claim 1, wherein the first assignment includes a first processing resource being assigned to perform a first task and a second processing resource being assigned to perform a second task, and wherein the adjustment to the first assignment includes a swap of the first and second computing resources such that the first processing resource is assigned to perform the second task and the second processing resource is assigned to perform the first task.
